(19) United States
(12) Patent Application Publication
(10) Pub. No.: US 2005/0028413 A1
(43) Pub. Date: Feb. 10, 2005

(54) Illuminated sign

(76) Inventor: John Rouse Packer, Uddingston (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/475,953

(22) PCT Filed: Apr. 26, 2002
(86) PCT No.: PCT/GB02/01873

(30) Foreign Application Priority Data
Apr. 26, 2001 (GB) 0110238.3

(51) Int. Cl. G09F 13/28

(52) U.S. Cl. 40/551

(57) ABSTRACT

A sign for conveying information, having a plastic body, illuminating means such as light emitting diodes (LEDs) mounted within the body and a reflective coating applied on a surface of the body carrying information to reflect light emitted from the illumination means back into the body of the sign. The sing may have the LEDs mounted to face an inside surface of the sign capable of scattering light to a transparent surface to produce an illuminated area. Scattering the light form scattering surface will produce a substantially even intensity of light across the illuminated area of the sign after its transmission form the sign.

This invention relates to illuminated signs and more particularly to improved illuminated signs which maximise the light output from illumination means within the sign to offer improved visibility and safety and furthermore, require lower power usage without loss of effectiveness.

Illuminated signs are a particularly useful selling tool for goods in shops. The signs can be illuminated in a variety of eye-catching colours to attract attention. Electrically illuminated signs may be mounted in the window or exterior of shops, guesthouses, hotels and other establishments to display information.

One known form of illuminated sign comprises one or more neon tubes which are formed into a particular shape such as a letter or a plurality of letters. These signs are relatively heavy to lift into position which makes the sign awkward to install without assistance. Furthermore, power to illuminate the sign is supplied from a mains power connection. The power required to run a single letter sign formed from a neon tube is around 0.5 W. If the sign has to be removed for cleaning either the window or the sign, due to the high voltages used for these signs, there is a danger that a person moving the sign may receive an electric shock.

An alternative to a shaped neon sign is known as a “sign box”. In this case, the sign is formed of a hollow plastics body upon which the information which the sign is to convey is provided and the illumination means are provided within the body. The illumination means in the signs are generally light emitting diodes, neon tubes, or standard light bulbs.

In this case, when the illumination means are on, the interior of the sign box is flooded with light which illuminates the front of the sign in order to draw attention to the information provided thereon. Where light emitting diodes are used, such signs are relatively simple to install and cheap to run, however the light emitted from the illumination means is not efficiently used in illuminating the sign. Light emitting diodes are, in effect, point sources of light. Therefore, signs illuminated using light emitting diodes typically consist of a plurality of point sources which illuminate the sign, usually through a partially transparent front section or by producing a “halo” effect around the side and/or back of a sign having an opaque front. In use, light emitting diodes produce a light pattern that is uneven in intensity across the illuminated area of the sign.

The present invention aims to provide an improved sign which overcomes or at least mitigates the problems which are associated with the above described known sign devices.

In accordance with a first aspect of the present invention there is provided a sign for conveying information, said sign comprising a body, at least one illuminating means mounted within the body, wherein the body is provided with light transmission means, for transmitting light from the body, said at least one illuminating means being positioned such that light emitted from the illuminating means is directed substantially to a light scattering interior surface of the body; the light being scattered from said light scattering surface prior to its transmission from the sign via the light transmission means.

Scattering the light from the scattering surface will produce a substantially even intensity of light across the illuminated area of the sign after its transmission from the sign.

Preferably, the body is made from a plastics material.

Preferably, the light transmission means is provided by a surface of the body which is at least in part transparent.

Optionally, a second light transmission means is provided by a space between surfaces of the body.

Optionally, a third light transmission means is provided by an aperture in at least one of the surfaces.

Preferably, the light scattering interior surface and the light transmission means are arranged opposite one another in the body.

Preferably, the illuminating means is at least one light emitting diode (LED).

Preferably the at least one light emitting diode is provided with a watertight housing.

Preferably the watertight housing is made from a moulded plastics material.

According to a second aspect of the present invention there is provided a sign for conveying information, said sign comprising a plastics body, illuminating means mounted within the body and a reflective coating applied on a surface of the body carrying information to reflect light emitted from the illumination means back into the body of the sign.

Advantageously, the sign body is formed of acrylic and may be formed in a casting process.

Preferably, the illuminating means comprises a light emitting diode (LED).

Advantageously, the illuminating means comprises a plurality of light emitting diodes (LEDs).

Conveniently, the light emitting diodes are distributed evenly throughout the body of the sign.

Preferably, the reflective coating is provided upon the entire surface of the sign body which carries the information.

Alternatively, the reflective coating is provided only on selected areas of the surface of the sign body carrying the information.

Conveniently, the reflective coating is interrupted in the region of the information which may take the form of letters, numerals or other insignia, which the sign is intended to convey.

In one embodiment, the light emitting diodes are provided along one edge of the sign body only and the reflective coating is applied to the surface of the sign body only in the region of the light emitting diodes. This provides an edge lit sign in which the light emitted from the diodes radiates throughout the body of the sign from one edge. The light emitting diodes may for example be provided along the upper edge of the sign such that the light radiates down through the body of the sign.

Aspects of the present invention will now be described with reference to and as shown in the accompanying drawings in which:—

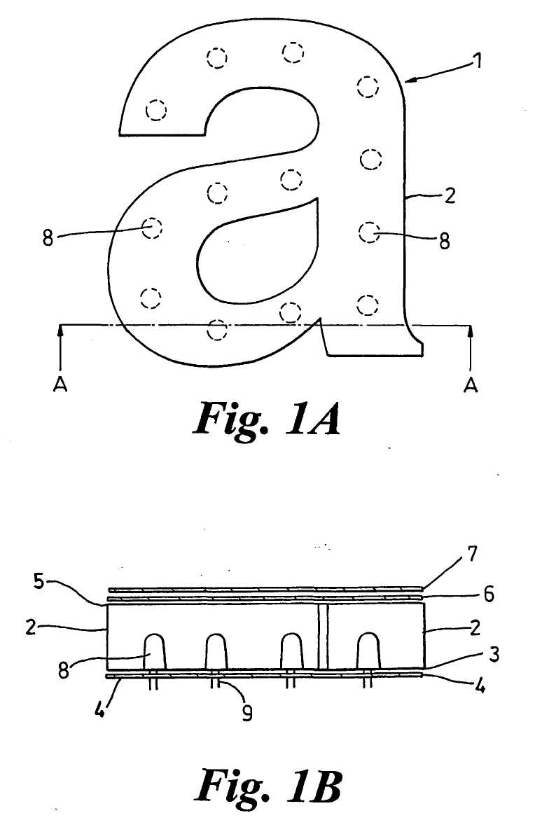

FIG. 1A is a plan view of a sign according to a first embodiment of the present invention;

FIG. 1B is a cross sectional view along the line A-A of FIG. 1;

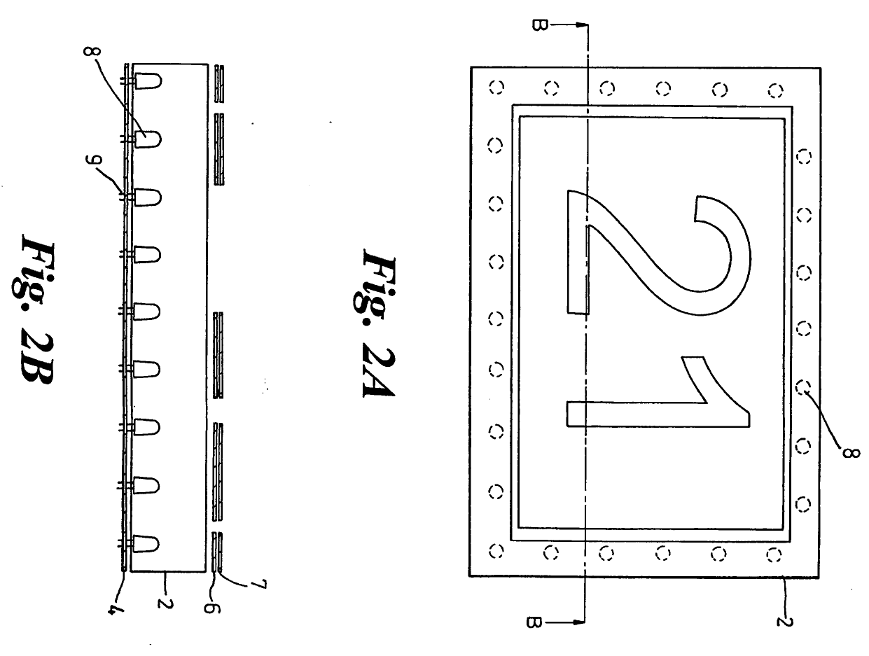

FIG. 2A is a plan view of a sign according to a second embodiment of the present invention;

FIG. 2B is a cross sectional view along the line B-B of FIG. 2A;

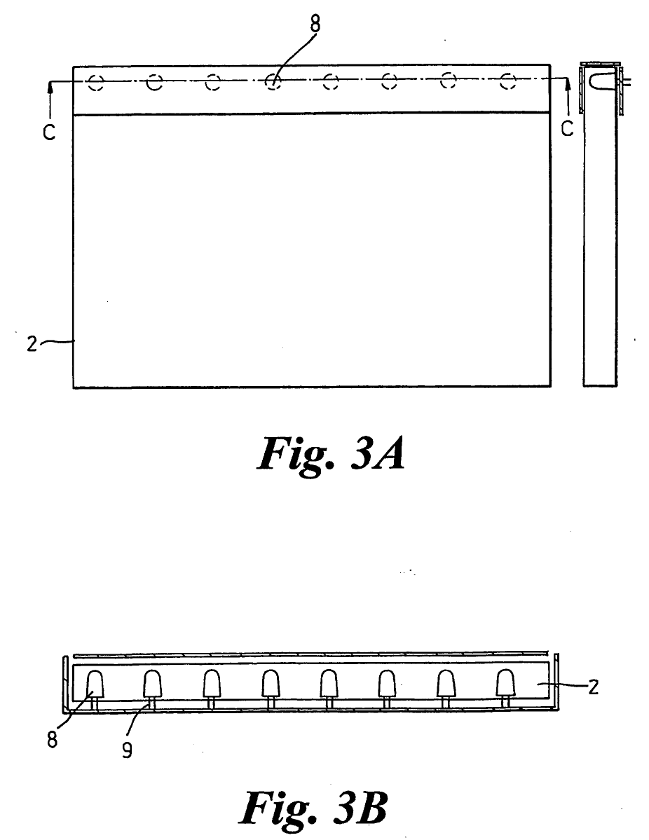

FIG. 3A is a plan view of a sign according to a third embodiment of the present invention;

FIG. 3B is a cross sectional view along the line C-C of FIG. 3A;

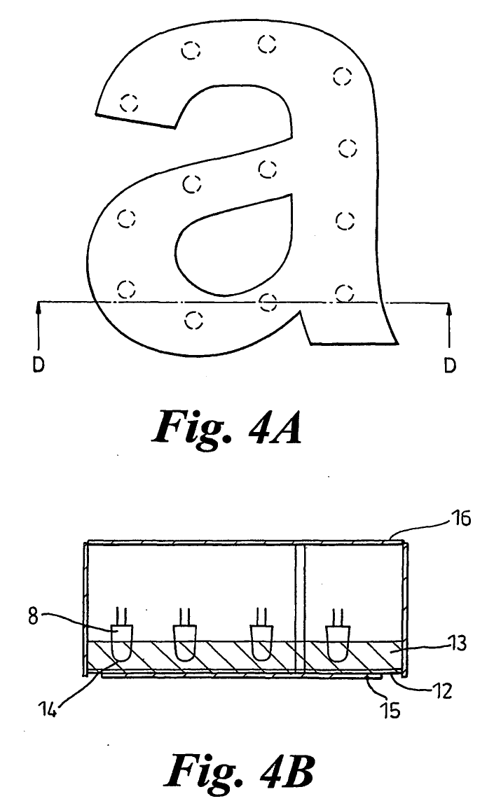

FIG. 4A is a plan view of a sign according to a fourth embodiment of the present invention;

FIG. 4B is a cross sectional view along the line D-D of FIG. 4A;

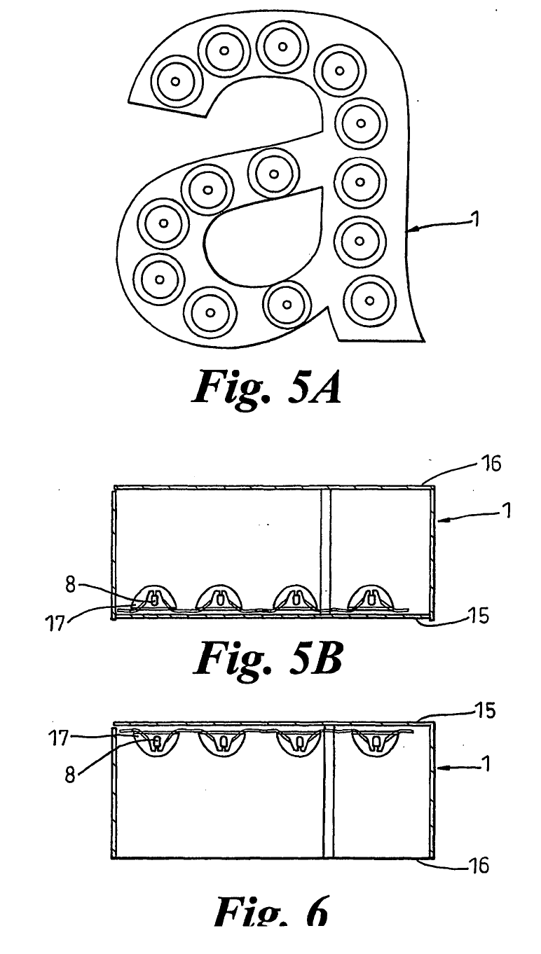

FIG. 5A is plan view of a sign according to a fifth embodiment of the present invention;

FIG. 5B is a cross sectional view along the line E-E of FIG. 5B;

FIG. 6 is a cross sectional view of a sixth embodiment of the present invention;

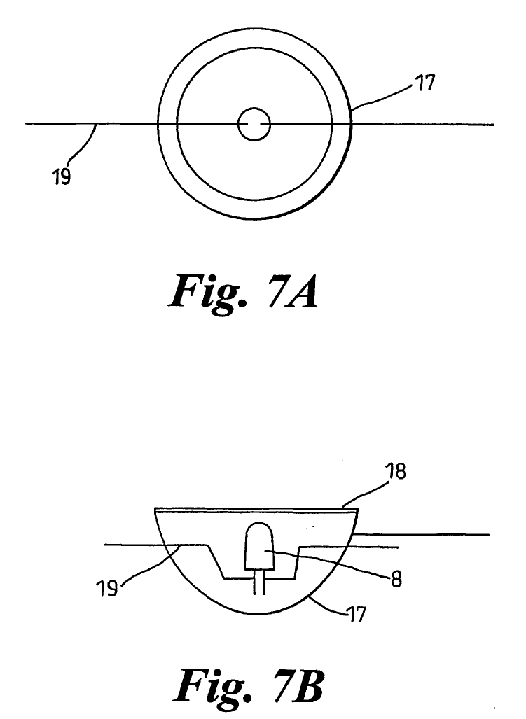

FIG. 7A is a cross sectional view of a light emitting diode encased in a watertight housing; and

FIG. 7B is a plan view of the light emitting diode and housing of FIG. 7A.

Turning now to the accompanying drawings, FIG. 1 shows a sign 1 which in this particular embodiment is formed into the shape of a letter “a”. The sign comprises a solid cast plastics body 2 which may be made of a material such as for example acrylic

The rear surface 3 of the sign is coated with a protective coating 4 which may be for example a clear lacquer. The protective coating may act to seal the electrical components (to be described below). The front surface 5 of the sign (the surface which will be in a window or on view to the public) is coated with a reflective coating 6 such as for example a suitable paint finish or mirrored coating. A surface finish 7 such as for example a decorative finish, a stainless steel facing, anodised aluminium facing, a paint finish or a plastics coating is applied to the front surface 5 of the sign over the reflective coating 6.

A light source, which in this embodiment is represented by a plurality of light emitting diodes 8, is mounted within the body 2 of the sign. The diodes may be equispaced around the sign body as shown in FIG. 1. The electrical connections 9 for the light emitting diodes pass through the protective coating 4 and means are provided (not shown) for connecting the light emitting diodes 8 to an electrical power source (not shown) for illumination.

When the light emitting diodes 8 of FIG. 1 are illuminated, light is emitted from the diodes and passes through the plastics body 2 of the sign. The light which is incident upon the inside of the front surface 5 of the sign body is reflected back into the sign by the reflective coating 6 and this has the effect of scattering light within the sign body. This scattered light exits the body of the sign through the sides thereof. Where no reflective coating is applied. This provides a clear sharp edge to the body 2 of the sign.

For a letter as shown in FIG. 1, the sign body 2 may be around 10 to 12 mm thick which is substantially less than present signage which is generally of the order of around 50 mm thick and thereby provides an immediate saving on materials.

A further embodiment of the present invention is shown in FIG. 2 in which the sign comprises a solid plastics sign body 2 as in the first embodiment. In this case however, the sign is not provided in the form of a letter, but is a substantially rectangular sign body 9 which could be hung in a window or above a window or door or a shop or the like.

In this case, the reflective coating 6 and the surface treatment 7 are not provided over the entire surface of the sign body 9. The coatings are interrupted on the front surface 5 of the sign in the region of the information which the sign conveys. In the embodiment shown, the information provided on the sign comprises the combination of the numerals “21” with a border around them. As shown in FIG. 2B, which is a cross section through the sign body 2 of FIG. 2A along the line B-B, the coatings 6, 7 are interrupted in the region of the numerals and the border.

Illuminating means in the form of light emitting diodes 8 are provided within the body 2 of the sign as shown in FIG. 2B. The light emitting diodes may be located around an edge 10 of the sign as illustrated in FIG. 2A, or alternatively they may be distributed throughout the body 2 of the sign. Where the light emitting diodes are provided throughout the body of the sign they are preferably evenly distributed.

In the embodiment shown in FIG. 3A, an edge-lit sign is shown. In this case, the sign body 2 is formed of a solid plastics material as in accordance with the other embodiments. In this embodiment, the light emitting diodes 8 are provided along the upper edge 11 of the sign body. A reflective coating 6 is provided on the front surface 5 of the sign in the region of the light emitting diodes.

In this embodiment, the reflective coating is provided not only on the front surface of the sign body but also on the rear surface and on the sides of the upper part of the sign body. Therefore, the entire area of the sign body containing the light emitting diodes is enclosed by the reflective coating. The coating could also be extended for example around the edge of the sign body to enhance the reflection of light within the sign.

Light emitted from the diodes which is incident upon the reflective coating is reflected back into the body of the sign and radiates through the sign from the source of the illumination. As the reflective coating is applied over each of the front, rear and sides of the upper portion of the sign body, light is reflected from each surface and encouraged to radiate throughout the sign body. This enables the entire sign body to be illuminated from a light source located at one edge only which is both cost effective to run and to manufacture and also provides for even illumination of the sign.

FIGS. 4A and 4B show a fourth embodiment of the invention. FIG. 4A is a plan view of a letter, containing an illuminating means 12 which consists of a plurality of light emitting diodes 8 embedded in a perspex block 13. The light emitting diodes are connected by means of electrical wires (not shown) to an electrical power source (not shown). The front of the light emitting diode 14 points towards a light scattering surface 15. Transparent surface 16 is arranged with respect to the light scattering surface such that the majority of the light emitted from the light emitting diode will be reflected and scattered from the light scattering surface 15 towards and through the transparent surface 16. Scattering of light will provide a more even light intensity distribution across the transparent surface, and provide more even illumination of the sign.

FIGS. 5A and 5B show a fifth embodiment of the present invention. FIG. 5A is a plan view of a letter containing a plurality of illuminating means being shown in more detail in FIGS. 5B, 6 and 7.

FIG. 5B shows a sign having a transparent surface 16 and light scattering surface 15, which, in this example, is opaque. The light emitting diodes are each mounted in a transparent watertight housing 17 made from perspex, in this example. It will be appreciated that other suitable materials may be used to construct the housing.

The housing is attached to the opaque light scattering surface such that the light emitting diode 8 points downwards towards the light scattering surface 15. In use, the light emitted from the light emitting diode will be mainly directed to the surface and will be scattered from the surface upwards towards and through the transparent surface.

In another example, the base of the housing may be opaque and can act to scatter the light emitted from the light emitting diode.

FIG. 6 shows another embodiment of the present invention. In this case the sign 1 is designed to be back lit to produce a “halo” lighting effect around opaque lettering. To achieve this effect, the light emitting diodes 8 face an opaque, light scattering front surface 15 of the letter and light is scattered backwards to a transparent surface 16 and out of the letter or symbol around its edges. As the light has been scattered from the opaque surface, a more even distribution of light intensities will arise.

FIGS. 7A and 7B show, in more detail, the housing 17 containing a light emitting diode 8 with connections 19 and a base 18.

This provides the advantage of enabling each light emitting diode 8 to be individually cast within such a housing thereby allowing a greater degree of flexibility regarding the type of signs which can be manufactured. For example, a combination of blocks containing three light emitting diodes could be combined with a number of these light emitting diodes to provide the lighting required by a particular design. In some examples, the cast may be coloured to create a coloured effect when light is transmitted through it.

Furthermore, individually housing each of the light emitting diodes effectively protects each of them from exposure to environmental factors such as rain and reduces the size of the cast normally required thereby also reducing the weight of the signage and the overall cost.

Signs manufactured in accordance with the above described embodiments of the present invention require little or no specialist installation. The signs run on a low voltage and so do not present a threat to users in relation to electric shocks. Furthermore, the signs have relatively low running costs which compared to currently used signs.

In addition, the signs described above can be easily cleaned and maintained and are particularly environmentally friendly as they do not radiate excessive amounts of heat into the surrounding environment.

Improvements and modifications may be incorporated herein without deviating from the scope of the invention.

1. A sign for conveying information, said sign comprising a body, at least one illuminating means mounted within the body, wherein the body is provided with light transmission means for transmitting light from the body, said at least one illuminating means being positioned such that light emitted from the illuminating means is directed substantially to a light scattering interior surface of the body, the light being scattered from said light scattering surface prior to its transmission from the sign via the light transmission means.

2. A sign according to claim 1, wherein the body is made from a plastic material.

3. A sign according to claim 1, wherein, the light transmission means is provided by a surface of the body which is a least in part, transparent.

4. A sign according to claim 1, wherein, a second light transmission means is provided by a space between surfaces of the body.

5. A sign according to claim 1, wherein, a third light transmission means is provided by an aperture in at least one of the surfaces.

6. A sign according to claim 1, wherein the light scattering interior surface and the light transmission means are arranged opposite one another in the body.

7. A sign according to claim 1, wherein the illuminating means is at least one light emitting diode (LED).

8. A sign according to claim 1, wherein the at least one light emitting diode is enclosed in a watertight housing.

9. A sign according to claim 8, wherein the watertight housing is made from molded plastic.

10. A sign for conveying information, said sign comprising a plastics body, illuminating means mounted within the body and a reflective coating applied on a surface of the body carrying information to reflect light emitted from the illumination means back into the body of the sign.

11. A sign according to claim 10, wherein the sign body is formed of acrylic.

12. A sign according to claim 10, wherein the sign is formed in a casting process.

13. A sign according to claim 10, wherein the illuminating means comprises at least one light emitting diode (LED).

14. A sign according to claim 10, wherein the illuminating means comprises a plurality of light emitting diodes.

15. A sign according to claim 14, wherein the light emitting diodes are distributed evenly throughout the body of the sign.

16. A sign according to claim 10, wherein the reflective coating is provided upon the entire surface of the sign body which carries the information.

17. A sign according to claim 10, wherein the reflective coating is provided only on selected areas of the surface of the sign body carrying the information.

18-19. (Canceled)
